(19) United States
(12) Patent Application Publication
(10) Pub. No.: US 2026/0303437 A1
(43) Pub. Date: Oct. 1, 2026

(54) METHOD AND SYSTEM FOR VALIDATING ROOT CAUSE ANALYSIS IN AN INFORMATION TECHNOLOGY INFRASTRUCTURE

(71) Applicant: HCL Technologies Limited, New Delhi (IN)

(72) Inventors: Navin Sabharwal, New Delhi (IN); Punith Krishnamurthy, Bangalore (IN)

(21) Appl. No.: 19/444,276

(22) Filed: Jan. 9, 2026

(30) Foreign Application Priority Data
Mar. 31, 2025 (IN) 202511032055

(51) Int. Cl. H04L 41/0631; H04L 41/14; H04L 41/16

(52) U.S. Cl. CPC H04L 41/0631; H04L 41/145; H04L 41/16

(57) ABSTRACT

A method and system for validating a root cause analysis in an Information Technology (IT) infrastructure is disclosed. A processor receives a topology graph corresponding to a root cause of an issue in the IT infrastructure. The topology graph comprises a causal node connected to a plurality of impacted nodes. A relevance classification information and a confidence score for each of the plurality of impacted nodes is determined using a pre-trained multi-class classification model. The relevance classification information comprises one of a relevant label or a not-relevant label. A validated topology graph corresponding to the root cause is determined based on one or more impacted nodes from the plurality of impacted nodes having the relevant label and the confidence score greater than a predefined threshold.

### TECHNICAL FIELD

This disclosure relates generally to the field of the Information Technology (IT) Service Management and particularly relates to a method and system for validating root cause analysis in an IT infrastructure.

### BACKGROUND

Information technology (IT) infrastructure may include various interconnected entities such as systems, services, and devices. These entities may be interdependent by sharing computational, storage, and network resources. Due to these interdependencies, an issue in one entity may result in a cascading impact on other dependent entities. Therefore, understanding the relationship between these entities is a critical step to identifying a root cause within the IT infrastructure. Dynamic and accurate mapping of dependencies enables organizations to minimize system downtime, optimize resource allocation, and improve service reliability. Conventionally, relationship information between entities is either manually configured by subject matter experts or derived using static configurations available in IT Service Management (ITSM) systems. However, such approaches often fail to adapt to the dynamic nature of IT infrastructure where frequent configuration changes, software updates, and infrastructure modifications occur. Existing RCA systems that attempt to discover relationships using event co-occurrence and temporal proximity often generate incorrect or incomplete topology graphs. These automatically derived graphs may contain false positive relationships (i.e., connections between events that are temporally aligned but not semantically or causally related). Such false relationships increase the complexity of RCA and lead to inaccurate identification of root causes.

Therefore, there is a requirement for an efficient methodology to validate root cause analysis in the IT infrastructure, in order to reduce false positives and enhance the accuracy of root cause identification in the IT infrastructure.

### SUMMARY OF THE INVENTION

In an embodiment, a method for validating a root cause analysis in an Information Technology (IT) infrastructure is disclosed. The method may include receiving, by a processor, a topology graph corresponding to a root cause of an issue in the IT infrastructure. In an embodiment, the topology graph may include a causal node connected to a plurality of impacted nodes. In an embodiment, the causal node may correspond to a causal event. In an embodiment, each of the plurality of impacted nodes may correspond to one of a plurality of impacted events. The method may further include determining, by the processor, a relevance classification information and a confidence score for each of the plurality of impacted nodes using a pre-trained multi-class classification model. In an embodiment, the relevance classification information may include one of a relevant label or a not-relevant label. In an embodiment, the multi-class classification model may be pre-trained using domain knowledge related to IT infrastructure and historical data. In an embodiment, the historical data may include a set of historically validated topology graphs corresponding to a set of root causes of a set of historical issues in the IT infrastructure. The method may further include determining, by the processor, a validated topology graph corresponding to the root cause based on one or more impacted nodes from the plurality of impacted nodes having the relevant label and the confidence score greater than a predefined threshold.

In an embodiment, a system for validating a root cause analysis in an Information Technology (IT) infrastructure is disclosed. The system may include a processor, and a memory communicatively coupled to the processor wherein, the memory stores processor-executable instructions, which when executed by the processor, cause the processor to receive a topology graph corresponding to a root cause of an issue in the IT infrastructure. In an embodiment the topology graph may include a causal node connected to a plurality of impacted nodes. In an embodiment, the causal node may correspond to a causal event. In an embodiment, each of the plurality of impacted nodes may correspond to one of a plurality of impacted events. The processor may further determine a relevance classification information and a confidence score for each of the plurality of impacted nodes using a pre-trained multi-class classification model. In an embodiment the relevance classification information may include one of a relevant label or a not-relevant label. In an embodiment the multi-class classification model may be pre-trained using domain knowledge related to IT infrastructure and historical data. In an embodiment the historical data may include a set of historically validated topology graphs corresponding to a set of root causes of a set of historical issues in the IT infrastructure. The processor may further determine a validated topology graph corresponding to the root cause based on one or more impacted nodes from the plurality of impacted nodes having the relevant label and the confidence score greater than a predefined threshold.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 is a block diagram of an exemplary system for validating a root cause analysis in an Information Technology (IT) infrastructure, in accordance with an embodiment of the present disclosure.

FIG. 2 is a block diagram of various modules within the memory of the computing device configured to validate a root cause analysis in an IT infrastructure, in accordance with an embodiment of the present disclosure.

FIG. 3 illustrates an exemplary first topology graph, in accordance with an embodiment of the present disclosure.

FIG. 4 illustrates an exemplary second topology graph, in accordance with an embodiment of the present disclosure.

FIG. 5 illustrates an exemplary third topology graph, in accordance with an embodiment of the present disclosure.

FIG. 6 illustrates an exemplary table depicting relevance classification information, in accordance with an embodiment of the present disclosure.

FIG. 7 illustrates an exemplary table depicting vector representation determined from event data, in accordance with an embodiment of the present disclosure.

FIG. 8 is a flow diagram of a methodology to validate a root cause analysis in an IT infrastructure, in accordance with an embodiment of the present disclosure.

FIG. 9 is a flow diagram of a methodology to preprocess the validated topology graph, in accordance with an embodiment of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

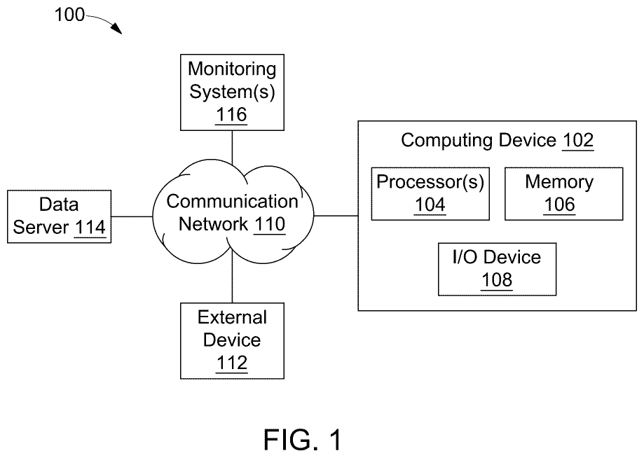

Referring now to FIG. 1, an exemplary system 100 for validating a root cause analysis in an information technology (IT) infrastructure, is illustrated, in accordance with an embodiment of the present disclosure. In an embodiment, the IT infrastructure may be implemented across various industries including information technology, healthcare, retail, finance, manufacturing, and telecommunications. In an embodiment, the IT infrastructure may include a set of entities, including but not limited to servers, databases, network devices, cloud computing resources, storage systems, and services. The system 100 may include a computing device 102, an external device 112, a data server 114, monitoring system(s) 116 communicably coupled to each other through a wired or wireless communication network 110. The computing device 102 may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, cause the processor 104 to perform root cause analysis in an information technology (IT) infrastructure, as will be discussed in greater detail herein below. In an embodiment, the memory 106 may also store a pre-trained multi-class classification model. In an embodiment, the memory 106 may be a non-volatile memory or a volatile memory. In an embodiment, the memory 106 may also store a single module or a combination of different modules to perform root cause analysis in an IT infrastructure. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database (not shown) to store a topology graph, causal nodes, impacted nodes, relevance classification information, historically validated topology graph, root causes of historical issues, and any other data necessary for the system 100 to validate a root cause analysis in the IT infrastructure. In an embodiment, the database may store data input by the external device 112 or output generated by the computing device 102. In an embodiment, the computing device 102 may be communicatively coupled with the data server 114 through the communication network 110.

In an embodiment, the communication network 110 may be a wired or a wireless network or a combination thereof. The communication network 110 can be implemented as one of the distinct types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 may receive a plurality of inputs from the external device 112 through the communication network 110. In an embodiment, the computing device 102 and the external device 112 may be a computing system, including but not limited to, a laptop computer, a desktop computer, a notebook, a workstation, a server, a portable computer, a handheld, or a mobile device. In an embodiment, the computing device 102 may be, but not limited to, in-built into the external device 112 or may be a standalone computing device.

In an embodiment, the monitoring systems 116 may include various hardware and software components configured to continuously track, analyse, and report events within the IT infrastructure. The monitoring systems 116 may include, but are not limited to, network monitoring tools, application performance monitoring (APM) systems, security information and event management (SIEM) solutions, infrastructure monitoring tools, and log management systems. These systems may be deployed across different layers of the IT infrastructure, including servers, databases, cloud resources, network devices, and application services. The monitoring systems 116 may collect a plurality of events and an associated event data corresponding to the set of entities of the IT infrastructure.

Further the computing device 102 may perform various functions in order to validate a root cause analysis in an IT infrastructure. By way of an example, the computing device 102 may receive a topology graph corresponding to a root cause of an issue in the IT infrastructure. In an embodiment, the topology graph may be generated based on a pre-trained large language model (LLM). In an embodiment, the topology graph may be generated based on a methodology described in co-filed patent application titled “METHOD AND SYSTEM FOR PERFORMING ROOT CAUSE ANALYSIS IN INFORMATION TECHNOLOGY INFRASTRUCTURE” incorporated herein in its entirety by reference. In an embodiment, the topology graph may include a causal node connected to a plurality of impacted nodes. In an embodiment, the causal node may correspond to a causal event. In an embodiment, each of the plurality of impacted nodes may correspond to one of a plurality of impacted events. In an embodiment, the causal node may be connected to each of the plurality of impacted nodes via an edge. In an embodiment, the corresponding edge may be indicative of a weighted relationship between the causal node and a corresponding impacted node from the plurality of impacted nodes.

Further the computing device 102 may determine a relevance classification information and a confidence score for each of the plurality of impacted nodes using a pre-trained multi-class classification model. In an embodiment, the relevance classification information may include one of a relevant label or a not-relevant label. In an embodiment, the multi-class classification model may be pre-trained using domain knowledge related to IT infrastructure and historical data. In an embodiment, the domain knowledge may include device configuration information, service dependency information, event log information, and performance metric information related to the IT infrastructure. In an embodiment, the historical data may include a set of historically validated topology graphs corresponding to a set of root causes of a set of historical issues in the IT infrastructure.

Further, the computing device 102 may validate the relevance classification information of each of the plurality of impacted nodes based on user feedback. Further the computing device 102 may determine a validated topology graph corresponding to the root cause based on one or more impacted nodes from the plurality of impacted nodes having the relevant label and the confidence score greater than a predefined threshold. In an embodiment, the validated topology graph may be determined based on the one or more impacted nodes validated based on the user feedback. In an embodiment, the validated topology graph may be determined by updating the corresponding edges between the causal node and the one or more impacted nodes. In an embodiment, the LLM may be pre-trained based on training data updated based on the validated root cause analysis.

Further, the computing device 102 may preprocess the validated topology graph to update the training data and the historical data. The computing device 102, in order to preprocess the validated topology graph, may determine vector representation of event data corresponding to the causal event and the one or more impacted events. In an embodiment, the event data may include event description, event parameters, and event title. The computing device 102, in order to preprocess the validated topology graph, may further determine a principal set of features from the event data based on a Principal Component Analysis (PCA) based on predefined number of dimensions.

Thereafter, the computing device 102 may retrain the multi-class classification model based on the updated historical data. The Computing device 102 may further retrain the LLM based on the updated training data.

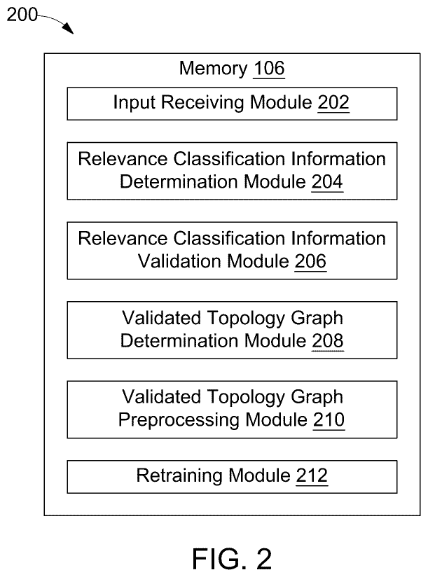

Referring now to FIG. 2, a block diagram 200 of various modules within the memory 106 of the computing device 102 configured to validate a root cause analysis in an IT infrastructure is illustrated, in accordance with an embodiment of the present disclosure. FIG. 2 is explained in conjunction with FIG. 1. The memory 106 may include an input receiving module 202, a relevance classification determination module 204, a relevance classification information validation module 206, a validated topology graph determination module 208, a validated topology graph preprocessing module 210, and a retraining module 212.

The input receiving module 202 may receive a topology graph corresponding to a root cause of an issue in the IT infrastructure. In an embodiment, the topology graph may be generated based on a pre-trained large language model (LLM). In an embodiment, the topology graph may be generated based on a methodology described in co-filed patent application titled “METHOD AND SYSTEM FOR PERFORMING ROOT CAUSE ANALYSIS IN INFORMATION TECHNOLOGY INFRASTRUCTURE” incorporated herein in its entirety by reference. In an embodiment, the topology graph may include a causal node connected to a plurality of impacted nodes. In an embodiment, the causal node may correspond to a causal event. Examples of causal events may include, but are not limited to, high CPU utilization on a server, process failure in a microservice, database connection timeout, network congestion on a specific switch, or security breach on a firewall appliance. In an embodiment, each of the plurality of impacted nodes may correspond to one of a plurality of impacted events. Impacted events may include system behaviour anomalies that occur as a result of the causal event, such as memory utilization spikes, degraded application performance, service unavailability, delayed response times, database query timeouts, or user login failures. In an embodiment, the causal node may be connected to each of the plurality of impacted nodes via an edge. In an embodiment, the corresponding edge may be indicative of a weighted relationship between the causal node and a corresponding impacted node from the plurality of impacted nodes.

The relevance classification determination module 204 may determine a relevance classification information and a confidence score for each of the plurality of impacted nodes using a pre-trained multi-class classification model. In an embodiment, the multi-class classification model may be configured to evaluate whether the relationship between a given causal event and each of the impacted events in the topology graph represents a valid dependency. In an embodiment, the relevance classification information may include one of a relevant label or a not-relevant label. For this purpose, the relevance classification information may include one of a binary set of class labels, such as a “relevant” label indicating that the impacted event is indeed causally or semantically linked to the causal event, or a “not-relevant” label indicating that the relationship between the causal and impacted event is likely coincidental or unrelated. The confidence score associated with each classification may represent a probability value or certainty metric generated by the classification model to indicate the level of confidence of the LLM model in the assigned label. In an embodiment, the multi-class classification model may be pre-trained using domain knowledge related to IT infrastructure and historical data. In an embodiment, the domain knowledge may include device configuration information, service dependency information, event log information, and performance metric information related to the IT infrastructure. In an embodiment, the historical data may include a set of historically validated topology graphs corresponding to a set of root causes of a set of historical issues in the IT infrastructure.

In an exemplary embodiment, the multi-class classification model may be a supervised machine learning model trained using historical RCA datasets and labelled feedback. The model may be pre-trained on input features derived from domain-specific data and previous root cause analysis cases. The domain knowledge used for training the model may comprise device configuration information (e.g., CPU, memory, network settings of the entity), service dependency mappings (e.g., interconnections between applications, APIs, and databases), historical event logs (e.g., alert messages, timestamps, error codes), and performance metrics (e.g., latency, throughput, resource utilization trends) collected from the IT infrastructure over time. These features may allow the multi-class classification model to learn typical behaviour patterns and dependency structures within the IT infrastructure. In an embodiment, the historical data used to train the classification model may include a set of previously generated and manually or semi-automatically validated topology graphs. Each such topology graph may correspond to a known root cause and a confirmed set of impacted entities, serving as ground truth for model learning. The validated topology graphs may have been constructed from past incidents in which the relationships between causal and impacted events were reviewed by experts or verified through resolution outcomes.

The relevance classification information validation module 206 may validate the relevance classification information of each of the plurality of impacted nodes based on user feedback. In an embodiment, the user feedback may be collected from administrators, operators, or subject matter experts who are responsible for managing or analyzing the IT infrastructure. The user may be presented with the automatically generated topology graph that includes the causal node and the corresponding plurality of impacted nodes, each annotated with a relevance label (such as “relevant” or “not-relevant”) and a confidence score. It should be noted that, the user feedback may be collected from a user via the I/O device 108 of the computing device 102, that enables the user to either confirm the suggested relevance classification or override it based on contextual understanding of the events and the infrastructure. In an embodiment, the feedback may be collected at the level of individual causal-impacted event pairs. The user may indicate whether a given impacted event is truly caused by the identified causal event or not. This feedback may be represented as a binary indicator (e.g., 1 for relevant, 0 for not relevant) or as a selection from predefined feedback categories. The feedback may also be optionally accompanied by justification notes, domain-specific observations, or references to monitoring data.

The validated topology graph determination module 208 may determine a validated topology graph corresponding to the root cause based on one or more impacted nodes from the plurality of impacted nodes having the relevant label and the confidence score greater than a predefined threshold. In an embodiment, the predefined threshold may be a configurable value that determines the minimum level of confidence required for an impacted event to be included in the validated topology graph. This allows the computing device 102 to filter out low-confidence or ambiguous event relationships, thereby improving the precision and interpretability of the resulting root cause analysis. In an embodiment, the validated topology graph may be determined based on the one or more impacted nodes validated based on the user feedback received through the relevance classification information validation module 206. In an embodiment, the validated topology graph may be determined by updating the corresponding edges between the causal node and the one or more impacted nodes. In an embodiment, the validated topology graph may be generated by updating the edges between the causal node and the one or more impacted nodes. Edges associated with impacted nodes classified as “not-relevant” or with a confidence score below the threshold may be removed or marked as invalid, while edges corresponding to validated relevant relationships may be retained or reinforced. In an embodiment, the LLM may be pre-trained based on training data updated based on the validated root cause analysis. In an embodiment, the validated topology graphs may be used to update the training data for the LLM that generates the initial topology graphs. This continuous learning loop ensures that the LLM is exposed to real-world validated dependency patterns to better infer causal-impact relationships in future incidents.

The validated topology graph preprocessing module 210 may preprocess the validated topology graph to update the training data and the historical data. In an embodiment, the preprocessing may involve feature extraction and dimensionality reduction operations that convert the event-level data associated with the validated causal and impacted relationships into structured, numerical representations suitable for training machine learning models. The validated topology graph preprocessing module 210, in order to preprocess the validated topology graph, may determine vector representation of event data corresponding to the causal event and the one or more impacted events. In an embodiment, the event data may include event description (e.g., “CPU utilization is high on server A”), event parameters (e.g., “CPU Spike Alert”), and event title (e.g., resource thresholds, timestamps, severity levels, and entity/service identifiers). In an embodiment, the event description may be processed using the LLM to generate semantic vector embeddings that capture contextual meaning. Additionally, device-level attributes such as entity type (e.g., server, application, database), service name, or parameter types (e.g., CPU, memory, latency) may be encoded as categorical variables using one-hot encoding or similar techniques. As an illustrative example, the event description “CPU utilization is high on server A” may be represented by a combination of LLM-generated semantic vectors (e.g., {23, 34, 41.2, . . . }) and one-hot encoded categorical attributes (e.g., [0,1], [1,0,1]) that together form a comprehensive feature vector for the event.

However, the semantic vector representations generated by LLMs typically contain a high number of dimensions, which can lead to increased computational complexity and may negatively impact model performance due to the curse of dimensionality. To address this, the validated topology graph preprocessing module 210 may further determine a principal set of features from the event data based on a Principal Component Analysis (PCA) based on predefined number of dimensions. In an embodiment, the validated topology graph preprocessing module 210 may apply a dimensionality reduction technique, such as Principal Component Analysis (PCA), to transform the high-dimensional semantic vectors into a reduced set of principal components that retain the most significant variance across the dataset. In an embodiment, PCA may be configured to retain approximately 95% of the total variance present in the original vectors. The number of principal components retained may vary depending on the training dataset characteristics.

Further, the retraining module 212 may retrain the multi-class classification model based on the updated historical data. In an embodiment, the historical data may include validated topology graphs generated from prior root cause analysis (RCA) workflows, along with corresponding feature representations of causal and impacted events. These feature representations may include a combination of reduced-dimensional semantic vectors and one-encoded categorical attributes derived during preprocessing. In an embodiment, the retraining module 212 may periodically or conditionally initiate retraining of the classification model using this updated historical dataset. The retraining module 212 may further retrain the LLM based on the updated training data. In an embodiment, the LLM may be fine-tuned using updated training data that includes event descriptions, root cause chains, and contextual entity relationships captured in the most recent validated RCA instances.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FGPA), programmable array logic, programmable logic device, and so forth. Alternatively, each of the modules 202-212 may be implemented in software for execution by several types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in various locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for validating root cause analysis in an information technology (IT) infrastructure. For example, the exemplary system 100 and the associated computing device 102 may validate root cause analysis in an IT infrastructure by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

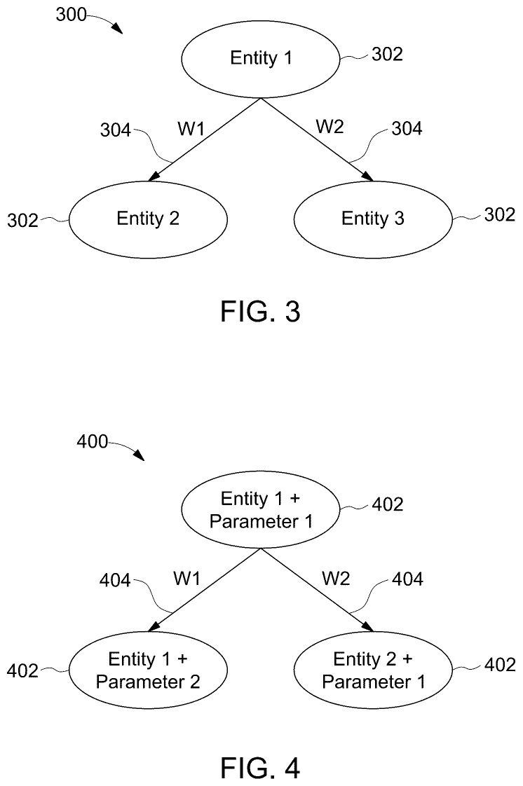

Referring now to FIG. 3, an exemplary first topology graph 300, is illustrated, in accordance with an embodiment of the present disclosure. FIG. 3 is explained in conjunction with the FIG. 2. In an embodiment, the topology graph 300 may be constructed based on temporal patterns observed between events detected within the information technology (IT) infrastructure. In FIG. 3, the topology graph 300 may include a set of nodes 302 and edges 304, where each node 302 represents an entity within the IT infrastructure, and each edge 304 represents a temporal relationship between the entities. The nodes 302 in the first topology graph 300 may represent entities such as servers, network devices, databases, or cloud services, each of which is associated with one or more events, as identified by the monitoring systems 116 within the IT infrastructure.

For example, Entity 1 could represent a primary server or application where an initial event, such as a CPU utilization spike, is detected. Entity 2 and Entity 3 represent other components that may be affected by this initial event, such as a dependent service or database. The nodes in the topology graph 300 represent individual entities within the IT infrastructure, such as servers, databases, or cloud services. For example, Entity 1, Entity 2, and Entity 3 each represent a distinct entity without explicitly specifying any associated event parameters. These entities are connected through edges 304, denoted by W1 and W2, which represent the strength or weight of the temporal relationships between the entities. The weights W1 and W2 quantify the correlational dependency based on the frequency and order of events occurring between the entities within a predefined time window. In this embodiment, the temporal information of the events is analysed to construct edges between the nodes. For instance, if events originating from Entity 1 frequently precede events at Entity 2within a short time frame, the weight W1 will increase, indicating a strong temporal dependency. Similarly, the weight W2 is determined based on the correlational strength between Entity 1 and Entity 3. In practice, the first topology graph 300 helps identify the causal and impacted nodes within the IT infrastructure. For example, Entity 1 may be determined as the causal node because it triggers events that propagate to downstream entities, represented by Entity 2 and Entity 3, which are identified as impacted nodes. By analysing the direction and strength of the edges, the computing device 102 may conclude that a failure or anomaly at Entity 1 is likely the root cause of the issues affecting the other entities. This information is crucial for generating root cause analysis (RCA) reports, which map causal events to impacted events and assist in incident resolution.

Referring now to FIG. 4, an exemplary second topology graph 400, is illustrated, in accordance with an embodiment of the present disclosure. FIG. 4 is explained in conjunction with the FIG. 2. The topology graph 400 represents a structure of interconnected nodes and edges that reflect the relationships between entities and the parameters associated with them. The nodes, labelled 402, correspond to entities within the IT infrastructure. Each entity may represent a component in the IT infrastructure, such as a server, database, network device, cloud resource, or application service. Additionally, the nodes 402 may include specific parameters (e.g., CPU usage, memory consumption) that may be associated with the events detected within the IT infrastructure. For instance, Entity 1+Parameter 1 may represent a server experiencing a high CPU usage event. The nodes in the topology graph 400 represent a combination of entities and their associated parameters. For example, Entity 1+Parameter 1 and Entity 2+Parameter 1 specify not only the entity involved but also the type of event or issue (such as CPU usage, memory consumption, or disk I/O) being tracked. The edges 404 may connect the nodes 402 in the second topology graph 400 between the entities. The weights, denoted as W1 and W2 may quantify the strength of the temporal dependencies based on the frequency and order of events occurring between the corresponding entities.

In the illustrated example, W1 represents the relationship between Entity+Parameter 1 and Entity 1+Parameter 2, while W2 represents the relationship between Entity 1+Parameter 1 and Entity 2+Parameter 1. The weights may be determined by analysing the occurrence patterns and temporal sequences of related events. In operation, the second topology graph 400 is constructed by first grouping related events to establish dependencies between the entities. The sequence and frequency of events is evaluated to compute the weights for the edges 404. For example, if an event corresponding to Entity 1+Parameter 1 frequently precedes an event at Entity 2+Parameter 1, the weight W2 may increase which indicates a strong causal relationship between the two entities.

The second topology graph 400 is essential for identifying causal nodes and impacted nodes within the IT infrastructure. In this embodiment, Entity 1+Parameter 1 may be identified as the causal node, triggering events that propagate to Entity 1+Parameter 2 and Entity 2+Parameter 1, which may be determined as impacted nodes. The direction and strength of the edges 404 may provide insights for identifying the origin of issues and their impact on other components in the infrastructure.

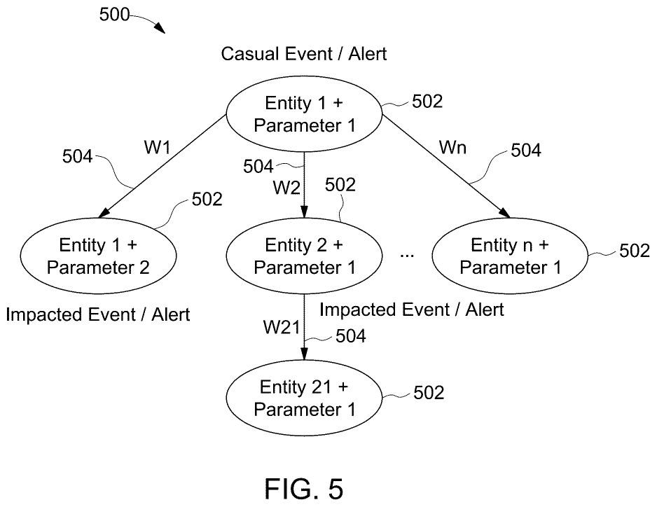

Referring now to FIG. 5, an exemplary third topology graph 500, is illustrated, in accordance with some embodiments of the present disclosure. The FIG. 5 is explained in conjunction with FIG. 2. The nodes, labelled 502, represent entities within the IT infrastructure, such as servers, network devices, cloud resources, and databases, each associated with one or more parameters. For example, Entity 1+Parameter 1 could represent a server experiencing a CPU utilization issue, while Entity 2+Parameter 1 could represent a dependent database service affected by the server's performance degradation. These nodes are connected by edges 504, which signify the weighted temporal relationships between the entities. The weights, labelled W1, W2, and Wn, quantify the strength and frequency of these temporal dependencies based on the sequence and co-occurrence of related events. In this embodiment, Entity 1+Parameter 1 is identified as a causal node, representing the root cause of the issue. Events originating from this node are likely to affect other nodes downstream, such as Entity 2+Parameter 1, Entity 1+Parameter 2, and Entity n+Parameter 1, which are classified as impacted nodes. The edge labelled W1 represents a temporal relationship between Entity 1+Parameter 1 and Entity 1+Parameter 2, indicating that an issue in one parameter (such as high CPU utilization) may lead to a related issue in another parameter (such as high memory usage) within the same entity. Similarly, the edge labelled W2 connects Entity 1+Parameter 1 to Entity 2+Parameter 1, representing a dependency between different entities. The edge Wn extends the causal relationship to Entity n+Parameter 1, indicating that the impact of the root cause may propagate to other services or devices in the infrastructure. Additionally, the edge W21 connects Entity 2+Parameter 1 to Entity 21+Parameter 1, illustrating a cascading effect where an issue affecting one entity can trigger secondary issues in other dependent entities. This propagation of events forms a network of causal and impacted relationships, allowing the system to identify the full scope of the problem and its potential downstream impacts.

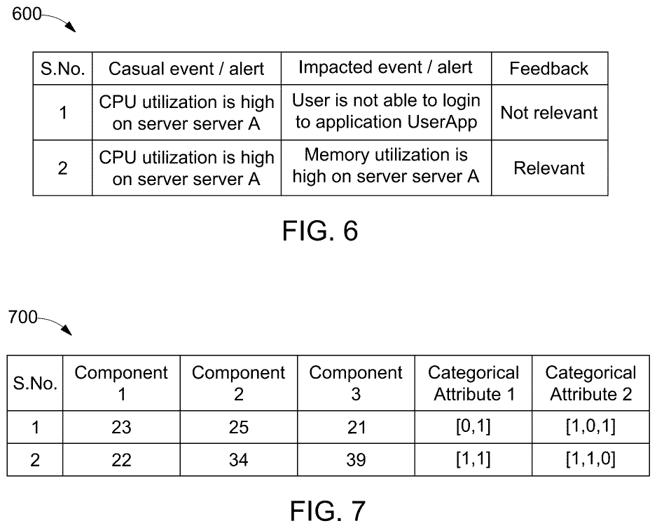

Referring now to FIG. 6, an exemplary table 600 depicting relevance classification information, is illustrated, in accordance with an embodiment of the present disclosure. FIG. 6 is explained in conjunction with the FIG. 2. The relevance classification determination module 204 may determine a relevance classification information corresponding to a causal node connected to a plurality of impacted nodes. The relevance classification information may include one of a relevant label or a not-relevant label. The table 600 may represent a sample feedback dataset used for validating the relevance of causal and impacted event relationships within a topology graph. The dataset shown in table 600 may be collected and managed by the relevance classification information validation module 206.

In an embodiment, table 600 may include multiple rows, where each row corresponds to a feedback instance that maps a causal event or alert to an impacted event or alert, along with the associated user feedback. Each entry includes a serial number (S. No.), a textual description of the causal event or alert, a textual description of the impacted event or alert, and a feedback label indicating whether the impacted event is considered relevant or not relevant in the context of the associated causal event. For example, in row 1, the causal event is “CPU utilization is high on server server A,” and the impacted event is “User is not able to login to application UserApp.” The feedback label for this relationship is “Not relevant,” indicating that although both events may have occurred within the same temporal window, the system administrator or user has identified that there is no meaningful or causal dependency between them. As a result, this relationship should not be included in the validated topology graph. In contrast, row 2 includes the same causal event (“CPU utilization is high on server server A”) but maps it to a different impacted event (“Memory utilization is high on server server A”). In this case, the feedback is “Relevant,” indicating a valid causal-impact relationship. This suggests that the high CPU utilization may have contributed to increased memory usage on the same server, and the impacted event should be retained in the validated topology graph. In an embodiment, such relevance classification information may be used as part of the training dataset for the multi-class classification model to learn and distinguish between meaningful and false relationships in topology graphs.

Referring now to FIG. 7, an exemplary table 700 depicting vector representation determined from event data, is illustrated, in accordance with an embodiment of the present disclosure. FIG. 7 is explained in conjunction with FIG. 2. The table 700 may represent the transformed and pre-processed output used for training or retraining the multi-class classification model. These feature vectors may be derived from validated topology graphs using the validated topology graph preprocessing module 210.

In an embodiment, each row in the table 700 corresponds to a single instance of a causal event and its associated impacted event, as extracted from the validated topology graph. The feature representation includes a set of principal features (Component 1, Component 2, Component 3) and a set of one-encoded categorical attributes (Categorical Attribute 1, Categorical Attribute 2). The set of principal features (Component 1, Component 2, Component 3) shown in table 700 may be the output of a dimensionality reduction process, such as Principal Component Analysis (PCA), applied to the vectorized representations of event descriptions. The original event descriptions such as “CPU utilization is high on server A” may first be converted into high-dimensional semantic vectors using the pre-trained large language model (LLM). The PCA transformation reduces the number of dimensions while retaining the majority of variance and semantic meaning. In addition to semantic vectors, each event pair may include categorical information such as device type, service name, metric type (e.g., CPU, memory), and severity level. These categorical values are encoded using one-encoding techniques and are captured in columns labelled Categorical Attribute 1 and Categorical Attribute 2 in the table 700. For instance, a service type or device type may be represented as [1,0,1] or [1,1], depending on the number of categories and active flags. These composite feature vectors including both the PCA-reduced components and one-encoded categorical values serve as the input to the multi-class classification model, which predicts whether a given impacted event is relevant or not relevant to the causal event.

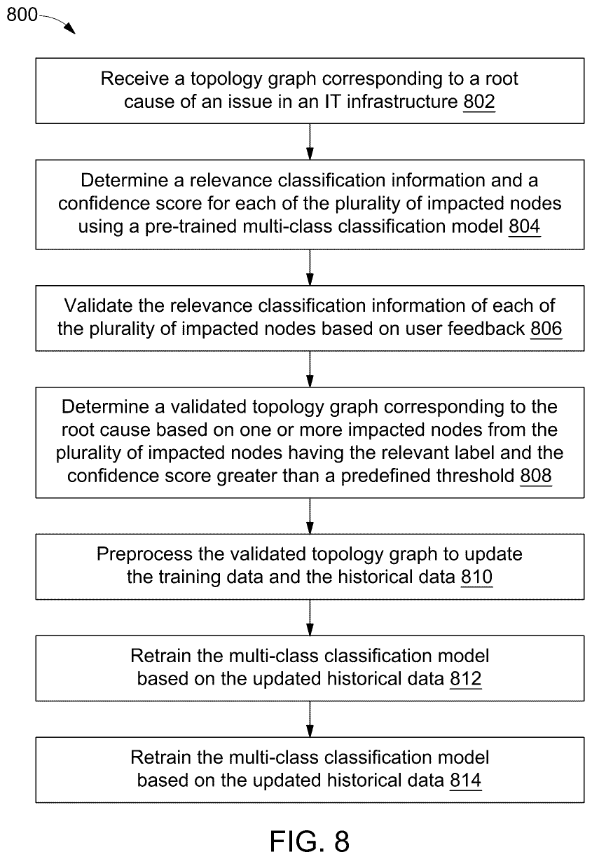

Referring now to FIG. 8, a flow diagram 800 of a methodology to validate a root cause analysis in an IT infrastructure, is illustrated, in accordance with an embodiment of the present disclosure. FIG. 8 is explained in conjunction with the FIGS. 1 and 2. In an embodiment, the flow diagram 800 may include a plurality of steps that may be performed by various modules of the computing device 102 so as to validate root cause analysis in the IT infrastructure.

At step 802, a topology graph corresponding to a root cause of an issue in the IT infrastructure may be received. In an embodiment, the topology graph may be generated based on a pre-trained large language model (LLM). In an embodiment, the topology graph may be generated based on a methodology described in co-filed patent application titled “METHOD AND SYSTEM FOR PERFORMING ROOT CAUSE ANALYSIS IN INFORMATION TECHNOLOGY INFRASTRUCTURE” incorporated herein in its entirety by reference. In an embodiment, the topology graph may include a causal node connected to a plurality of impacted nodes. In an embodiment, the causal node may correspond to a causal event. In an embodiment, each of the plurality of impacted nodes may correspond to one of a plurality of impacted events. In an embodiment, the causal node may be connected to each of the plurality of impacted nodes via an edge. In an embodiment, the corresponding edge may be indicative of a weighted relationship between the causal node and a corresponding impacted node from the plurality of impacted nodes.

Further at step 804, a relevance classification information and a confidence score for each of the plurality of impacted nodes may be determined using a pre-trained multi-class classification model. In an embodiment, the relevance classification information may include one of a relevant label or a not-relevant label. In an embodiment, the multi-class classification model may be pre-trained using domain knowledge related to IT infrastructure and historical data. In an embodiment, the domain knowledge may include device configuration information, service dependency information, event log information, and performance metric information related to the IT infrastructure. In an embodiment, the historical data may include a set of historically validated topology graphs corresponding to a set of root causes of a set of historical issues in the IT infrastructure.

Further at step 806, the relevance classification information of each of the plurality of impacted nodes may be validated based on user feedback. Further at step 808, a validated topology graph corresponding to the root cause may be determined based on one or more impacted nodes from the plurality of impacted nodes having the relevant label and the confidence score greater than a predefined threshold. In an embodiment, the validated topology graph may be determined based on the one or more impacted nodes validated based on the user feedback. In an embodiment, the validated topology graph may be determined by updating the corresponding edges between the causal node and the one or more impacted nodes. In an embodiment, the LLM may be pre-trained based on training data updated based on the validated root cause analysis. Further at step 810, the validated topology graph may be pre-processed to update the training data and the historical data. Further at step 812, the multi-class classification model may be retrained based on the updated historical data. Further at step 814, the LLM may be retrained based on the updated training data.

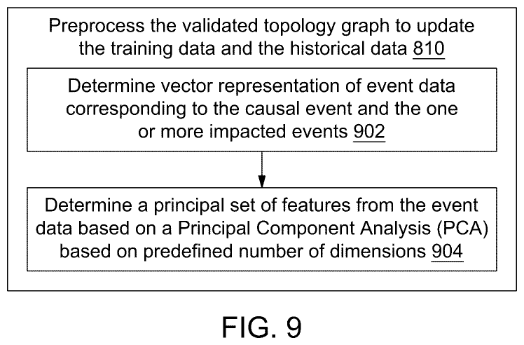

Referring now to FIG. 9, a flow diagram of a methodology to preprocess the validated topology graph, is illustrated, in accordance with an embodiment of the present disclosure. FIG. 9 is explained in conjunction with the FIG. 8. In an embodiment, the flow diagram may include a plurality of steps that may be performed by various modules of the computing device 102 so as to preprocess the validated topology graph.

At step 902, vector representation of event data corresponding to the causal event and the one or more impacted events may be determined. In an embodiment, the event data may include event description, event parameters, and event title. Further at step 904, a principal set of features from the event data may be determined based on a Principal Component Analysis (PCA) based on predefined number of dimensions.

Thus, the disclosed method 800 and system 100 tried to overcome the technical problem of inaccurate or incomplete root cause analysis in dynamic Information Technology (IT) infrastructure environments due to false positive relationships generated by topology discovery tools. Existing systems often infer causal-impact relationships solely based on temporal co-occurrence of events, without validating the correctness of those relationships using contextual understanding or historical relevance.

The disclosed method 800 and system 100 addresses these challenges by validating the relationships between causal and impacted events in a topology graph using a pre-trained multi-class classification model that is continuously updated based on user feedback and domain knowledge. Further, the system preprocesses validated topologies by generating feature vectors from event descriptions and infrastructure parameters, applies dimensionality reduction techniques such as Principal Component Analysis (PCA), and retrains the classification model and large language model (LLM) as part of a closed feedback-learning loop. This enables accurate, scalable, and adaptive RCA validation, thereby enhancing the reliability and operational efficiency of IT infrastructure management.

As will be appreciated by those skilled in the art, the techniques described in the various embodiments discussed above are not routine, or conventional, or well-understood in the art. The techniques discussed above provide for validating root cause analysis in an IT infrastructure.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and system for validating root cause analysis in an IT infrastructure. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fibre optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It is intended that the disclosure and examples be considered as exemplary only, with a true scope and spirit of disclosed embodiments being indicated by the following claims.

What is claimed is:

1. A method for validating a root cause analysis in an Information Technology (IT) infrastructure, the method comprising:
receiving, by a processor, a topology graph corresponding to a root cause of an issue in the IT infrastructure,
wherein the topology graph comprises a causal node connected to a plurality of impacted nodes, wherein:
the causal node corresponds to a causal event,
each of the plurality of impacted nodes correspond to one of a plurality of impacted events;
determining, by the processor, a relevance classification information, and a confidence score for each of the plurality of impacted nodes using a pre-trained multi-class classification model,
wherein the relevance classification information comprises one of a relevant label or a not-relevant label,
wherein the multi-class classification model is pre-trained using domain knowledge related to IT infrastructure and historical data, and
wherein the historical data comprises a set of historically validated topology graphs corresponding to a set of root causes of a set of historical issues in the IT infrastructure; and
determining, by the processor, a validated topology graph corresponding to the root cause based on one or more impacted nodes from the plurality of impacted nodes having the relevant label and the confidence score greater than a predefined threshold.

2. The method as claimed in claim 1, further comprises:
validating, by the processor, the relevance classification information of each of the plurality of impacted nodes based on user feedback,
wherein the validated topology graph is determined based on the one or more impacted nodes validated based on the user feedback.

3. The method as claimed in claim 2, wherein the topology graph is generated based on a pre-trained large language model (LLM), wherein the LLM is pretrained based on training data updated based on the validated root cause analysis.

4. The method as claimed in claim 3, wherein the causal node is connected to each of the plurality of impacted nodes via an edge,
wherein the corresponding edge is indicative of a weighted relationship between the causal node and a corresponding impacted node from the plurality of impacted nodes, and
wherein the validated topology graph is determined by updating the corresponding edges between the causal node and the one or more impacted nodes.

5. The method as claimed in claim 4, further comprises:
preprocessing, by the processor, the validated topology graph to update the training data and the historical data, wherein the preprocessing comprises:
determining, by the processor, vector representation of event data corresponding to the causal event and the one or more impacted events, wherein the event data comprises event description, event parameters, and event title; and
determining, by the processor, a principal set of features from the event data based on a Principal Component Analysis (PCA) based on predefined number of dimensions.

6. The method as claimed in claim 5, further comprising:
retraining, by the processor, the multi-class classification model based on the updated historical data; and
retraining, by the processor, the LLM based on the updated training data.

7. The method as claimed in claim 1, wherein the domain knowledge comprises device configuration information, service dependency information, event log information, and performance metric information related to the IT infrastructure.

8. A system for validating a root cause analysis in an Information Technology (IT) infrastructure, comprising:
a processor; and
a memory communicatively coupled to the processor, wherein the memory stores processor-executable instructions, which when executed by the processor, cause the processor to:
receive a topology graph corresponding to a root cause of an issue in the IT infrastructure,
wherein the topology graph comprises a causal node connected to a plurality of impacted nodes, wherein:
the causal node corresponds to a causal event,
each of the plurality of impacted nodes correspond to one of a plurality of impacted events;
determine a relevance classification information and a confidence score for each of the plurality of impacted nodes using a pre-trained multi-class classification model,
wherein the relevance classification information comprises one of a relevant label or a not-relevant label,
wherein the multi-class classification model is pre-trained using domain knowledge related to IT infrastructure and historical data, and
wherein the historical data comprises a set of historically validated topology graphs corresponding to a set of root causes of a set of historical issues in the IT infrastructure; and
determine a validated topology graph corresponding to the root cause based on one or more impacted nodes from the plurality of impacted nodes having the relevant label and the confidence score greater than a predefined threshold.

9. The system as claimed in claim 8, wherein the processor-executable instructions, when executed by the processor, cause the processor to:
validate the relevance classification information of each of the plurality of impacted nodes based on user feedback,
wherein the validated topology graph is determined based on the one or more impacted nodes validated based on the user feedback.

10. The system as claimed in claim 9, wherein the topology graph is generated based on a pre-trained large language model (LLM), wherein the LLM is pretrained based on training data updated based on the validated root cause analysis.

11. The system as claimed in claim 10, wherein the causal node is connected to each of the plurality of impacted nodes via an edge,
wherein the corresponding edge is indicative of a weighted relationship between the causal node and a corresponding impacted node from the plurality of impacted nodes, and
wherein the validated topology graph is determining by updating the corresponding edges between the causal node and the one or more impacted nodes.

12. The system as claimed in claim 11, wherein the processor-executable instructions, when executed by the processor, cause the processor to:
preprocess the validated topology graph to update the training data and the historical data, wherein to preprocess, the processor-executable instructions, when executed by the processor, cause the processor to:
determine vector representation of event data corresponding to the causal event and the one or more impacted events, wherein the event data comprises event description, event parameters, and event title; and
determine a principal set of features from the event data based on a Principal Component Analysis (PCA) based on predefined number of dimensions.

13. The system as claimed in claim 12, wherein the processor-executable instructions, when executed by the processor, cause the processor to:
retrain the multi-class classification model based on the updated historical data; and
retrain the LLM based on the updated training data.

14. The system as claimed in claim 8, wherein the domain knowledge comprises device configuration information, service dependency information, event log information, and performance metric information related to the IT infrastructure.

15. A non-transitory computer-readable medium storing computer-executable instructions for validating a root cause analysis in an Information Technology (IT) infrastructure, the computer-executable instructions configured for:
receiving a topology graph corresponding to a root cause of an issue in the IT infrastructure,
wherein the topology graph comprises a causal node connected to a plurality of impacted nodes, wherein:
the causal node corresponds to a causal event,
each of the plurality of impacted nodes correspond to one of a plurality of impacted events;
determining a relevance classification information, and a confidence score for each of the plurality of impacted nodes using a pre-trained multi-class classification model,
wherein the relevance classification information comprises one of a relevant label or a not-relevant label,
wherein the multi-class classification model is pre-trained using domain knowledge related to IT infrastructure and historical data, and
wherein the historical data comprises a set of historically validated topology graphs corresponding to a set of root causes of a set of historical issues in the IT infrastructure; and
determining a validated topology graph corresponding to the root cause based on one or more impacted nodes from the plurality of impacted nodes having the relevant label and the confidence score greater than a predefined threshold.

16. The non-transitory computer-readable medium of claim 15, wherein the computer-executable instructions are further configured for:
validating the relevance classification information of each of the plurality of impacted nodes based on user feedback,
wherein the validated topology graph is determined based on the one or more impacted nodes validated based on the user feedback.

17. The non-transitory computer-readable medium of claim 16, wherein the topology graph is generated based on a pre-trained large language model (LLM), wherein the LLM is pretrained based on training data updated based on the validated root cause analysis.

18. The non-transitory computer-readable medium of claim 17, wherein the causal node is connected to each of the plurality of impacted nodes via an edge,
wherein the corresponding edge is indicative of a weighted relationship between the causal node and a corresponding impacted node from the plurality of impacted nodes, and
wherein the validated topology graph is determined by updating the corresponding edges between the causal node and the one or more impacted nodes.

19. The non-transitory computer-readable medium of claim 18, wherein the computer-executable instructions are further configured for:
preprocessing the validated topology graph to update the training data and the historical data, wherein the preprocessing comprises:
determining vector representation of event data corresponding to the causal event and the one or more impacted events, wherein the event data comprises event description, event parameters, and event title; and
determining a principal set of features from the event data based on a Principal Component Analysis (PCA) based on predefined number of dimensions.

20. The non-transitory computer-readable medium of claim 19, wherein the computer-executable instructions are further configured for:
retraining the multi-class classification model based on the updated historical data; and
retraining the LLM based on the updated training data.

21. The non-transitory computer-readable medium of claim 15, wherein the domain knowledge comprises device configuration information, service dependency information, event log information, and performance metric information related to the IT infrastructure.
